(19) United States
(12) Patent Application Publication
(10) Pub. No.: US 2017/0265706 A1
(43) Pub. Date: Sep. 21, 2017

(54) CLEANING AN ITEM

(71) Applicant: The Dial Corporation, Scottsdale, AZ (US)

(72) Inventor: Stephen Koven, Scottsdale, AZ (US)

(21) Appl. No.: 15/075,578

(22) Filed: Mar. 21, 2016

(51) Int. Cl. A47L 15/00; D06F 33/02

(52) U.S. Cl. CPC A47L 15/0021; A47L 15/0063; D06F 33/02; H04W 4/021

(57) ABSTRACT

Methods and systems are provided for cleaning an item. The methods and systems include, with a cleaning system programmed to perform the method obtaining, with a location circuit, a location of a cleaning device, the cleaning device to be used to clean the item, based on the location of the cleaning device, determining environmental conditions for that location, and based on the environmental conditions for that location, presenting, via a user interface (UI), a recommendation to improve cleanliness of the item when cleaning the item with the cleaning device.

### FIELD OF THE INVENTION

The present invention generally relates to cleaning an item, and more particularly relates to providing a recommendation to clean the item based on a location.

### BACKGROUND OF THE INVENTION

Items include an article of clothing, an article of fabric or a kitchen utensil. An article of clothing is, for example, a T-shirt, a dress shirt, pants, coats, sweaters, ties, and other clothing. An article of fabric is, for example, sheets, blankets, comforters, couch covers, and other textiles. The kitchen utensil is, for example, eating utensils, kitchenware, ovenware, bakeware, cookware, silverware, glassware or other kitchen utensils. The items are subjected to a cleaning process, via a cleaning device, to improve cleanliness of the item.

Accordingly, it is desirable to clean an item by an optimal cleaning process to improve cleanliness of the item. Furthermore, other desirable features and characteristics of the present invention will become apparent from the subsequent detailed description of the invention and the appended claims, taken in conjunction with the accompanying drawings and this background of the invention.

BRIEF SUMMARY OF THE INVENTION

A method is provided for cleaning an item. The method includes with a cleaning system programmed to perform the method obtaining, with a location circuit, a location of a cleaning device, the cleaning device to be used to clean the item, based on the location of the cleaning device, determining environmental conditions for that location, and based on the environmental conditions for that location, presenting, via a user interface (UI), a recommendation to improve cleanliness of the item when cleaning the item with the cleaning device.

A system for cleaning an item includes a database to store information relating to environmental conditions for a number of locations and store recommendations for each of the locations based on environmental conditions associated with a respective location and a cleaning system to with a location circuit, obtain a location of a cleaning device to be used to clean the item, access the database, based on the location of the cleaning device, determine the environmental conditions for that location and with a UI, present, based on the environmental conditions for that location, at least one of the recommendations to improve cleanliness of the item when cleaning the item with the cleaning device.

A computer program product is provided for cleaning an item. The computer program product includes a non-transitory tangible computer readable storage medium. The tangible computer readable storage medium includes computer readable program code embodied therewith, the computer readable program code includes program instructions that, when executed, cause a processor to store information relating to environmental conditions for a number of locations, based on a location of a cleaning device, determine the environmental conditions for that location, and based on the environmental conditions for that location, present, via a UI, a recommendation to improve cleanliness of an item when cleaning the item with the cleaning device

### BRIEF DESCRIPTION OF THE DRAWINGS

The present invention will hereinafter be described in conjunction with the following drawing figures, wherein like numerals denote like elements, and uses of the invention. Furthermore, there is no intention to be bound by any theory presented in the preceding background of the invention or the following detailed description of the invention.

FIG. 1 is a diagram of a system for cleaning an item, according to one example of principles described herein.

FIG. 2 is a diagram of a system for cleaning an item, according to one example of principles described herein.

FIG. 3A is an example of a recommendation, according to one example of principles described herein.

FIG. 3B is an example of a recommendation, according to one example of principles described herein.

FIG. 4 is a flowchart of a method for cleaning an item, according to one example of principles described herein.

FIG. 5 is a flowchart of a method for cleaning an item, according to one example of principles described herein.

FIG. 6 is a diagram of a system for cleaning an item, according to one example of the principles described herein.

FIG. 7 is a diagram of a cleaning system, according to one example of the principles described herein.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, an item is an article of clothing, an article of fabric or a kitchen utensil. Often, when the item is used or worn by a person, the item becomes unclean. Once the item becomes unclean, the item is then subjected to a cleaning process to improve cleanliness of the item. If the item is an article of fabric, the cleaning process includes, for example, washing the article of fabric via a cleaning device such as a washing machine. If the item is a kitchen utensil, the cleaning process includes, for example, washing the kitchen utensils via a cleaning device such as a dishwasher.

Often, an item is subjected to a cleaning process at a location. A location includes, for example, a neighborhood, a city, a state, a country, or a continent. Depending on the location where the item is being subjected to the cleaning process, conditions specific to that location might impact the cleaning of the item at that location. Conditions could include, for example, common stains associated with that location, a type of soil found at that location, water conditions for that location, regional foods associated with that location, current weather conditions for that location, other conditions, or combinations thereof. Further, some cleaning processes are effective in improving cleanliness of an item being subjected to these cleaning processes at a particular location. However, these same cleaning processes are ineffective in improving the cleanliness of the item being subjected to these cleaning processes at a different location. As a result, a cleaning process can be optimal for a one location, but not for another location. If the item is subjected to a cleaning process that is not optimal for a particular location, the cleanliness of the item is not improved. This can lead to subjecting the item to the same cleaning process several times without improving the cleanliness of the item. Further, this can lead to experimenting with other cleaning processes by trial and error to improve the cleanliness of the item.

The principles described herein include a system and a method for cleaning an item. Such a system and method include with a cleaning system programmed to perform the method obtaining, with a location circuit, a location of a cleaning device, the cleaning device to be used to clean the item, based on the location of the cleaning device, determining environmental conditions for that location, and based on the environmental conditions for that location, presenting, via a user interface (UI), a recommendation to improve cleanliness of the item when cleaning the item with the cleaning device. Such a system and method presents a recommendation that is optimal for the location to improve the cleanliness of the item.

In the present specification and in the appended claims, the term “item” means an article that is subjected to a cleaning process. For example, the item might be an article of clothing, an article of fabric or a kitchen utensil. An article of clothing is, for example, a T-shirt, a dress shirt, pants, coats, sweaters, ties, and other clothing. An article of fabric is, for example, sheets, blankets, comforters, couch covers, and other textiles. The kitchen utensils are, for example, eating utensils, kitchenware, ovenware, bakeware, cookware, silverware, glassware or other kitchen utensils.

In the present specification and in the appended claims, the term “cleaning device” means a mechanism used to clean an item. For example, the cleaning device may be a washing machine or a dishwasher.

In the present specification and in the appended claims, the term “cleaning process” means a procedure or a series of steps that are utilized to clean an item. If the item is an article of fabric, the cleaning process includes, for example, washing the article of fabric via a cleaning device, such as a washing machine. The cleaning process includes cleaning the article of fabric at a specific temperature, with a detergent, utilizing a specific setting of the washing machine, other cleaning processes, or combinations thereof. This can broadly include pre-treating, hand washing, dry cleaning, and other cleaning processes. If the item is a kitchen utensil, the cleaning process includes, for example, washing the kitchen utensils via a cleaning device, such as a dishwasher. The cleaning process includes cleaning the kitchen utensil at a specific temperature, with a detergent, utilizing a specific setting of the dishwasher, other cleaning processes, or combinations thereof.

In the present specification and in the appended claims, the term “environmental conditions” means conditions specific to a location that might impact the cleaning of an item at that location. Thus, the environmental conditions might affect the cleanliness of an item before and/or during a cleaning process. The environmental conditions could include, for example, common stains associated with a location, a type of soil found at the location, water conditions for the location, regional foods associated with the location, current weather conditions for the location, or combinations thereof.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

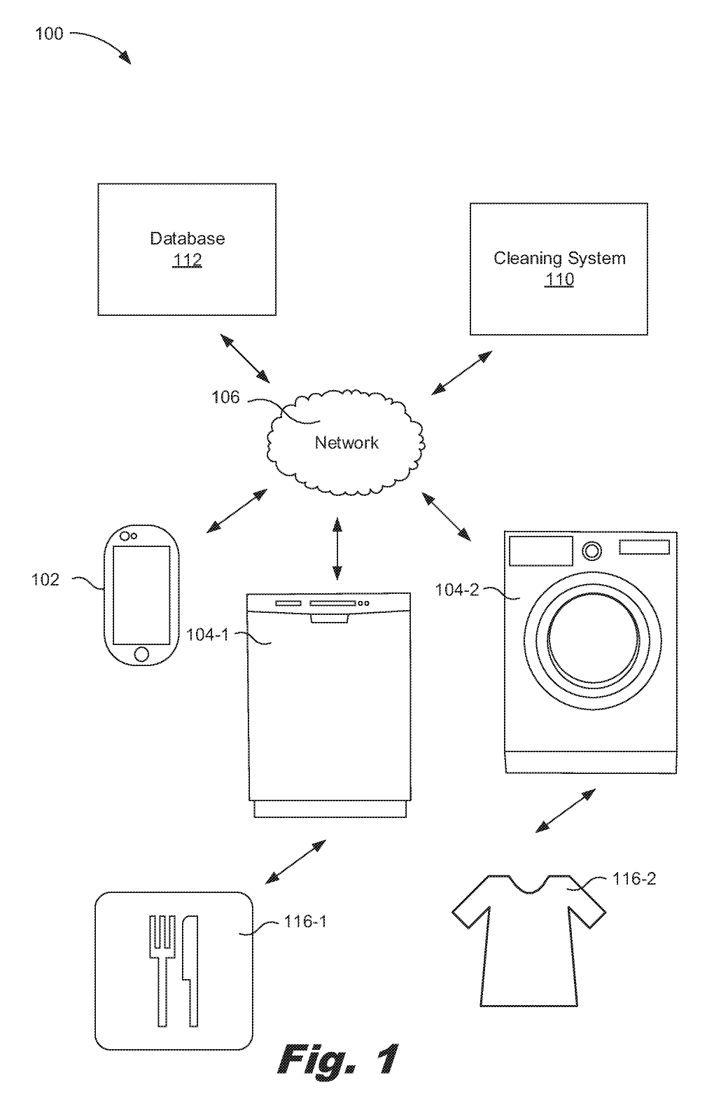

FIG. 1 is a diagram of a system for cleaning an item, according to one example of principles described herein. As will be described below, a cleaning system is in communication with a network to obtain, with a location circuit, a location of a cleaning device, the cleaning device to be used to clean the item. Further, the cleaning system based on the location of the cleaning device, determines environmental conditions for that location. The cleaning system based on the environmental conditions for that location, presents, via a UI, a recommendation to improve cleanliness of the item when cleaning the item with the cleaning device.

As illustrated in FIG. 1, the system (100) includes a mobile device (102). The mobile device (102) is a handheld device that allows the cleaning system (110), to determine a location of a cleaning device (104) and present a recommendation, to a user, via a UI.

The system (100) includes a number of cleaning device (104). The cleaning devices (104) are mechanisms used to clean an item (116). For example, a cleaning device is a dishwasher (104-1) or a washing machine (104-2).

The system (100) further includes a cleaning system (110). The cleaning system (110) obtains, with a location circuit, a location of a cleaning device (104), the cleaning device (104) to be used to clean the item (116). As will be described below, the location circuit is integrated into the mobile device (102) or one of the cleaning devices (104).

The cleaning system (110) further, based on the location of the cleaning device, determines environmental conditions for that location. As will be described below, the location includes a house address, a city, a county, a country, a continent, a longitudinal coordinate, a latitudinal coordinate, or combinations thereof.

Further, the cleaning system (110) based on the environmental conditions for that location, presents, via a UI, a recommendation to improve cleanliness of the items (116) when cleaning the items (116) with the cleaning device (104). As a result, the system (100) presents a recommendation that is optimal for the location to improve the cleanliness of the item (116). More information about the cleaning system (110) will be described later on in this specification.

While this example has been described with reference to the cleaning system being located over the network, the cleaning system may be located in any appropriate location according to the principles described herein. For example, the cleaning system may be located in a mobile device, a server, a database, a cleaning device, other locations, or combinations thereof.

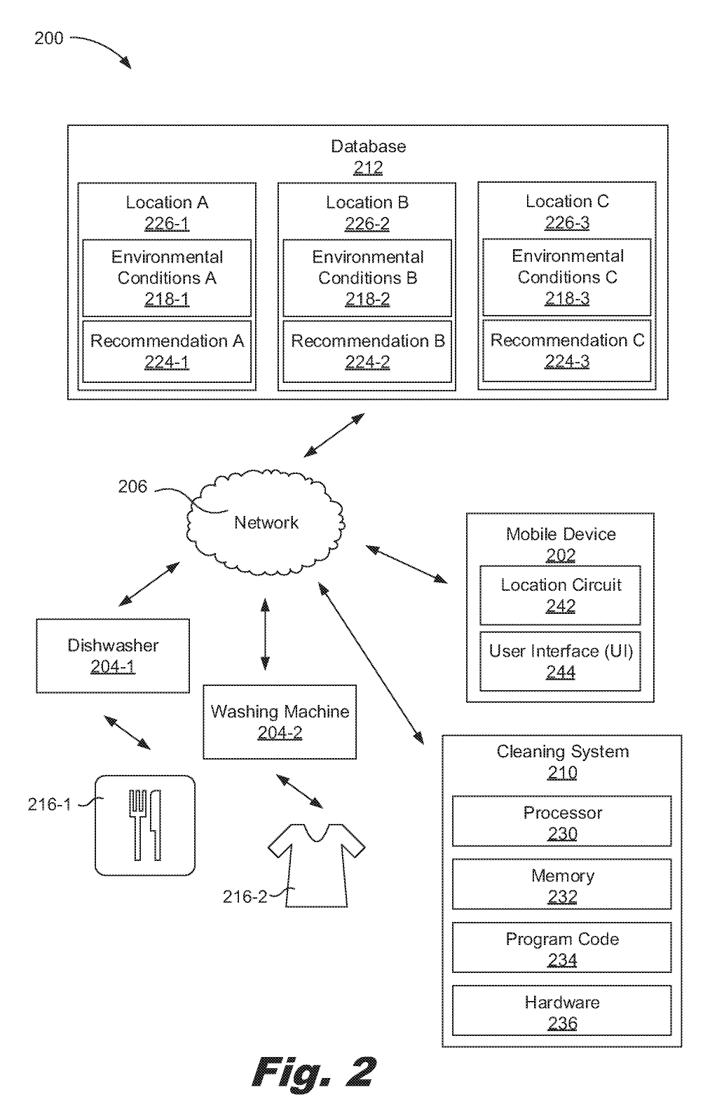

FIG. 2 is a diagram of a system for cleaning an item, according to one example of principles described herein. As will be described below, a cleaning system is in communication with a network to obtain, with a location circuit, a location of a cleaning device, the cleaning device to be used to clean the item. Further, the cleaning system based on the location of the cleaning device, determines environmental conditions for that location. The cleaning system based on the environmental conditions for that location, presents, via a UI, a recommendation to improve cleanliness of the item when cleaning the item with the cleaning device.

As illustrated the system (200) includes a database (212). The database stores, in memory, a number of locations (226). For example, the locations (226) include location A (226-1), location B (226-2), and location C (226-3). In this example, each of the locations (226) is defined by a house address, a city, a county, a country, a continent, a longitudinal coordinate, a latitudinal coordinate, or combinations thereof. For example, location A (226-1) is defined by a city within a state, such as Mesa Ariz. Further, since Mesa Ariz. is associated with the United States of America, the North American continent, a latitudinal coordinate of 33.42286 degrees north, a longitudinal coordinate of −111.8322 degrees east, location A (226-1) could be defined by any of these. Location B (226-2) is defined by a latitudinal coordinate of 41.03485 degrees north and a longitudinal coordinate of −111.9377 degrees east. Location C (226-3) is defined as Orange County.

Further, environmental conditions (218) for each of the locations (226) are stored in the database (212). Environmental conditions include conditions specific to a location that might impact the cleaning of an article at that location. Thus, the environmental conditions might affect the cleanliness of an item before and/or during a cleaning process. The environmental conditions could include, for example, common stains associated with a location. The common stains may be a result of soil found at the location, vegetation such as a type of grass found that the location or common foods associated with the location.

The environmental conditions could include, for example, the type of soil found at a location. The soil found at the location is defined be a number of characteristics. The characteristics include, for example, soil color. The soil color indicates the composition of the soil. The soil can be for example, black, white, red, brown, yellow, and under the right conditions green. Soil color is influenced by the amount of proteins present in the soil. A soil that is yellow or red in color indicates the presence of iron oxides. A soil that is brown or black in color indicates that the soil has high organic matter content. The presence of specific minerals also affects the color of the soil. For example, manganese oxide causes the soil to become black in color. Glauconite turns the soil green in color. Calcite turns soils in arid regions white in color. Depending on protein, organic matter content, and minerals found in the soil, different types of cleaning processes and/or recommendations are utilized to improve the cleanliness of an item.

The characteristics further include, for example, a soil texture. The soil texture is determined by the relative proportions of matter found in the soil. This includes sand, clay, and silt. Depending on the proportions of sand, clay, and silt found in the soil, different types of cleaning processes and/or recommendations are utilized to improve the cleanliness of an item.

The environmental conditions could include, for example, water conditions for the location. Water conditions can be defined by the harness or the softness of the water at the location. In an example, hard water is water that is high in mineral content. Hard water is formed when water percolates through deposits of limestone and chalk. These deposits are largely made up of calcium and magnesium carbonates. Soft water is water that is low in mineral content. Depending on if the water for the location is hard water or soft water, different types of cleaning processes and/or recommendations are utilized to improve the cleanliness of the item (216).

The environmental conditions could include, for example, regional foods associated with the location. In an example, regional foods may be dependent on the time of year. For example, during the months of April to June, a regional food, such as strawberries is associated with a location. As a result, strawberries may stain the items (216). Depending on the regional foods and time of year, different types of cleaning processes and/or recommendations are utilized to improve the cleanliness of the items (216).

The environmental conditions could include, for example, current weather conditions for the location. Current weather conditions include dry weather conditions, humid weather conditions, hot weather conditions, cold weather conditions, or other weather conditions or combinations there. Depending on the current weather conditions, different types of cleaning processes and/or recommendations are utilized to improve the cleanliness of the items (216).

In this example, environmental conditions A (218-1) is associated with location A (226-1). Environmental conditions A (218-1) include a red clay type of soil, soft water conditions, a regional food such as strawberries, and dry weather condition for location A (226-1).

As illustrated, environmental conditions B (218-2) is associated with location B (226-2). Environmental conditions B (218-2) include a brown clay type of soil, hard water conditions, and dry weather condition for location B (226-2).

Environmental conditions C (218-3) is associated with location C (226-3). Environmental conditions C (218-3) include a soil composed mostly of sand, hard water conditions, a regional food such as oranges, vegetation such as Saint Augustine grass, and heat and humid weather conditions for location C (226-3).

Further, recommendations (224) for each of the locations (226) are stored in the database (212). The recommendations (224) are a process or a series of step that are utilized to improve cleanliness of an item for a respective location. The recommendations (224) may be displayed, via a UI (244-1), to a user. In some examples, the more specific the locations (226), the more specific recommendations can be. For example, since location B (226-2) is defined by a latitudinal coordinate and a longitudinal coordinate instead of for example a continent, a more specific recommendation is provided for location B (226-2).

As illustrated, recommendation A (224-1) is associated with location A (226-1). Since red clay is common in location A (226-1), recommendation A (224-1) includes a process or steps to remove the red clay from an item (216). In this example, recommendation A (224-1) includes the following steps: 1) Carefully remove any visible red clay from the item. A soft brush is an effective tool to remove excess without damaging fabrics. 2) Using a container such as a five gallon bucket or a sink, soak the item in warm water with a detergent that includes both anionic and nonionic surfactants and enzymes for at least 45 minutes. In this step, the enzymes especially, cellulose removes pilling. In an example, pills hold on to the red clay. 3) Wash the item in hot water with a detergent that contains both surfactants and enzymes as described in step 2. In an example, the hot water may be the highest water temperature setting allowed for the item. Further, hot water dissolves the red clay more easily because all reaction times become faster at hotter temperatures. 4) Evaluate item before placing the item in a dryer to make sure the red clay has been removed from the item. If the red clay is not removed, repeat steps 1-3.

Recommendation B (224-2) is associated with location B (226-2). Recommendation B (224-2) includes add detergent Z to your dishwasher to improve the cleanliness of your dishes. In some examples, detergent Z is designed to be used in locations with hard water. Since location B (226-2) includes hard water, detergent Z may be an optimal recommendation. As a result, the recommendation can present a specific type of product.

Recommendation C (224-3) is associated with location C (226-3). Since Saint Augustine grass is common in location A (226-1), recommendation A (224-1) includes a process or steps to remove the Saint Augustine grass from an item (216). In this example, recommendation A (224-1) includes the following steps: 1) Carefully remove any visible grass from the item. A soft brush is an effective tool to remove excess without damaging fabrics. 2) Using a container such as a five gallon bucket or a sink, soak the item in warm water with a detergent that includes both anionic and nonionic surfactants and enzymes for at least 45 minutes. In this step, the enzymes especially, protease attaches grass proteins. 3) Wash the item in hot water with a detergent that contains both surfactants and enzymes as described in step 2. In an example, the hot water may be the highest water temperature setting allowed for the item. Further, hot water dissolves the Saint Augustine grass more easily because all reaction times become faster at hotter temperatures. 4) Evaluate item before placing the item in a dryer to make sure the Saint Augustine grass has been removed from the item. If the Saint Augustine grass is not removed, repeat steps 1-3.

As illustrated the system (200) includes a number of cleaning devices (204). The cleaning devices (104) are mechanisms used to clean an item (216). For example, a cleaning is a washing machine (204-2) or a dishwasher (204-1). Each of the cleaning devices (204) is specific to the type of item (216). For example, the dishwasher (204-1) cleans items such as kitchen utensils. The kitchen utensils are, for example, eating utensils, kitchenware, ovenware, bakeware, cookware, silverware, glassware or other kitchen utensils. The washing machine (204-2) cleans items such as articles of clothing and articles of fabric. An article of clothing is, for example, a T-shirt, a dress shirt, pants, coats, sweaters, ties, and other clothing. An article of fabric is, for example, sheets, blankets, comforters, couch covers, and other textiles.

Further, each of the cleaning devices (204) subjects the item (216) to a cleaning process. The cleaning process is a procedure or a series of steps that are utilized to clean an item (216). If the item is an article of fabric, the cleaning process includes, for example, washing the article of fabric via a cleaning device, such as a washing machine (204-2). As described above a recommendation recommends a specific temperature, a detergent, a specific setting of the washing machine (204-2), or combinations thereof that should be used to improve cleanliness of the item. The recommendation can broadly include pre-treating, hand washing, dry cleaning, and other cleaning processes. If the item is a kitchen utensil, the cleaning process includes, for example, washing the kitchen utensils via a cleaning device, such as a dishwasher (204-1). As will be described below a recommendation recommends a specific temperature, a detergent, a specific setting of the dishwasher (204-1), or combinations thereof that should be used to improve cleanliness of the item.

As illustrated the system (200) includes a mobile device (202). The mobile device (202) includes a location circuit (242). The mobile device (202) is used to allow the cleaning system (110) to determine a location of a cleaning device (104) via the location circuit (242). The location circuit (242) is, for example, a global positioning system (GPS) circuit that includes hardware and software. The location circuit (242) is such that the cleaning system (210) can access the location circuit (242) to determine a location of a cleaning device (204).

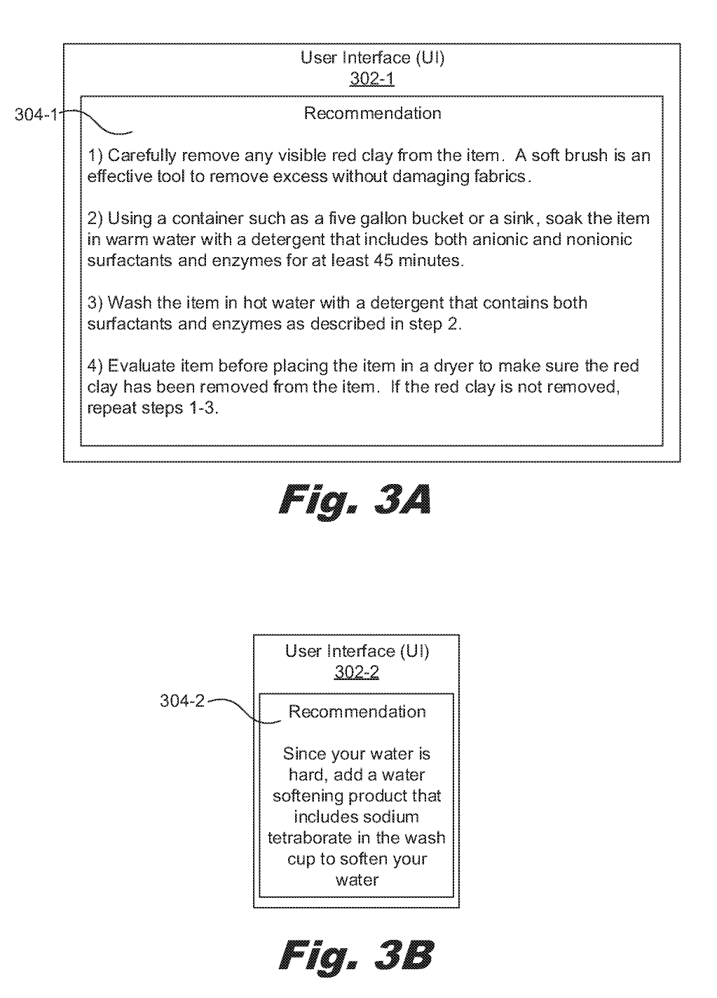

The mobile device (202) is used to allow the cleaning system (210) to present a recommendation to a user. The recommendation is presented to the user via the UI (244). Examples of recommendations are provided in FIGS. 3A and 3B.

The system (200) further includes the cleaning system (210). The cleaning system (210) includes, but not limited to, a processor (230), memory (232), program code (208), and/or hardware (236). The processor (230), memory (232), program code (208), and/or hardware (236) are used to implement the functionality of the system (200). For example, the memory (232) and/or program code (208) stores instructions that when executed cause the processor and/or hardware (236) to perform the functions described below. In some examples, the cleaning system (210) accesses, via a network (206), the database (212), the location circuit (242), the UI (244), the mobile device (202), the dishwasher (204-1), or the washing machine (204-2). As a result, the cleaning system (210) can send and/or retrieve information to and/or from the database (212), the location circuit (242), the UI (244), the mobile device (202), the dishwasher (204-1), or the washing machine (204-2). In some examples, the functions of the cleaning system (210) are activated based on an event. For example, an event such as turning on the cleaning devices (204) actives all the functions of the cleaning system (210) described below.

The cleaning system (210) stores information relating to the environmental conditions (218) for a number of locations (226) in a database (212). In some examples, the information relating to the environmental conditions (218) for a number of locations (226) are manually inputted into a database (212). In other examples, the database (212) accesses other databases and/or systems that determine and/or store the information. For example, the database (212) accesses a weather database to determine current weather conditions for each of the locations (226). Once the current weather conditions are determined for each of the locations (226) from the weather database, information associated with the current weather conditions are stored in the database (212) as environmental conditions (218) for each respective location (226).

The cleaning system (210) stores recommendations (224) for each of the locations (226) based on the environmental conditions (218) associated with a respective location. In an example, the recommendation includes utilizing a specific cleaning process for cleaning the item (216) with the cleaning device (204). This can broadly include pre-treating, hand washing, dry cleaning, and other cleaning processes.

The recommendation includes utilizing specific detergent for cleaning the item (216) with the cleaning device (204). The specific detergent broadly includes a form of detergent such as powders or concentrated detergents. A chemical composition of a detergent such as anionic detergents, cationic detergents, non-ionic and zwitterionic detergents.

The recommendation includes utilizing specific bleach for cleaning the item (216) with the cleaning device (204). The specific bleach includes oxidizing bleach, a reducing bleach, or sunlight. A class of bleach such as chlorine-based bleach or peroxide-based bleach. The chlorine-based bleach includes, for example, sodium hypochlorite, bleaching power, and chlorine, chlorine dioxide. The peroxide-based bleach includes, for example, hydrogen peroxide, sodium percarbonate, and sodium percarbonate.

The recommendation includes utilizing a specific water temperature for cleaning the item (216) with the cleaning device (204). The specific water temperature includes hot water, warm water, or cold water. In some examples, the specific water temperature is defined in Fahrenheit or Celsius.

The recommendation includes utilizing specific settings of the cleaning device (204) for cleaning the item (216) with the cleaning device (204). The specific settings of the cleaning device (204) includes, for example, a delicate cycle, an extra rinse, a soiled setting such as lightly soiled or heavily soiled, or specific settings, or combinations thereof.

The cleaning system (210) obtains, with the location circuit (242), a location of a cleaning device (204), the cleaning device (204) to be used to clean the item (216). For example, the cleaning system (210) obtains, with the location circuit (242), the location of the washing machine (204-2) as location A (226-1). Although FIG. 2 illustrates the location circuit (242) and the UI (244) integrated into the mobile device (202), the location circuit (242) and the UI (244) can be integrated into a cleaning device (204).

The cleaning system (210) based on the location of the cleaning device, determining environmental conditions for that location. For example, since the washing machine (204-2) is located in location A (226-1), environmental conditions A (218-1) is determined for that location.

The cleaning system (210) based on the environmental conditions for that location, presenting, via a UI (244), a recommendation to improve cleanliness of the item when cleaning the item with the cleaning device. In this example, recommendation A (224-1) is presented via the UI (244).

FIG. 3A is an example of a recommendation, according to one example of principles described herein. As mentioned above, the determining system presents, via a UI, a recommendation.

As illustrated, a UI (302-1) presents, to a user, a recommendation (304-1) based on environmental conditions for a location, a recommendation to improve cleanliness of the item when cleaning the item with the cleaning device. In this example, the recommendation (304-1) recommends the steps of: 1) Carefully remove any visible red clay from the item. A soft brush is an effective tool to remove excess without damaging fabrics. 2) Using a container such as a five gallon bucket or a sink, soak the item in warm water with a detergent that includes both anionic and nonionic surfactants and enzymes for at least 45 minutes. 3) Wash the item in hot water with a detergent that contains both surfactants and enzymes as described in step 2. 4) Evaluate item before placing the item in a dryer to make sure the red clay has been removed from the item. If the red clay is not removed, repeat steps 1-3.

FIG. 3B is an example of a recommendation, according to one example of principles described herein. As mentioned above, the determining system presents, via a UI, a recommendation.

As illustrated, a UI (302-2) presents, to a user, a recommendation (304-1) based on environmental conditions for a location, a recommendation to improve cleanliness of the item when cleaning the item with the cleaning device. In this example, the recommendation (304-2) recommends since your water is hard, add a water softening product that includes sodium tetraborate in the wash cup to soften your water.

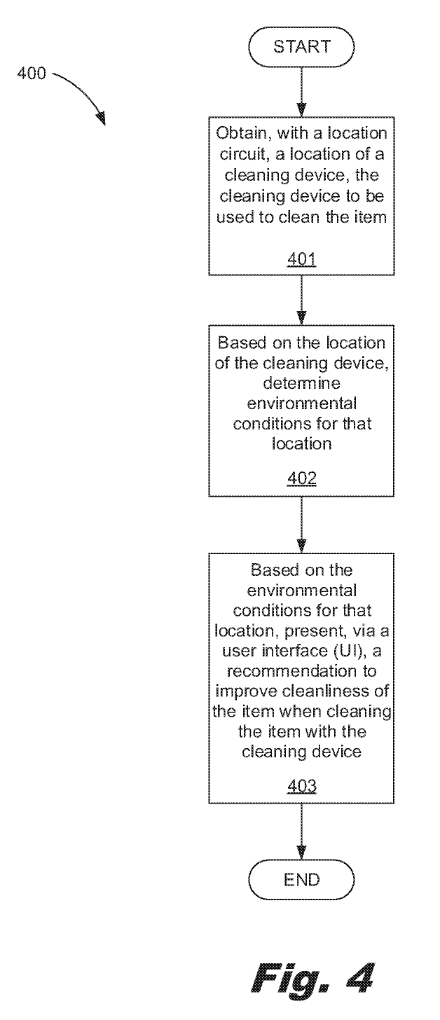

FIG. 4 is a flowchart of a method for cleaning an item, according to one example of principles described herein. In one example, the method (400) is executed by the system (100) of FIG. 1. In other examples, the method (400) is executed by other systems such as system 200 system 600 or system 700. In this example, the method (400) includes obtaining (401), with a location circuit, a location of a cleaning device, the cleaning device to be used to clean the item, based on the location of the cleaning device, determining (402) environmental conditions for that location, based on the environmental conditions for that location and presenting (403), via a UI, a recommendation to improve cleanliness of the item when cleaning the item with the cleaning device.

As mentioned above, the method (400) includes obtaining (401), with a location circuit, a location of a cleaning device, the cleaning device to be used to clean the item. In an example, the location circuit is integrated into a mobile device. In this example, the mobile device is in proximity to the cleaning device. As a result, the method (400) accesses the location circuit on the mobile device to obtain the location of the cleaning device.

In another example, the location circuit is integrated into the cleaning device. In this example, since the location circuit is integrated into the cleaning device, the method (400) does not need a mobile device to obtain a location of the cleaning device. As a result, the method (400) accesses the location circuit on the cleaning device to obtain the location of the cleaning device.

As mentioned above, the method (400) includes based on the location of the cleaning device, determining (402) environmental conditions for that location. In some examples, the method (400) determines at least one environmental condition for that location from a database. As a result, the method (400) accesses the database and determines environmental conditions for that location.

As mentioned above, the method (400) includes based on the environmental conditions for that location, presenting (403), via a UI, a recommendation to improve cleanliness of the item when cleaning the item with the cleaning device. In some examples, one recommendation is presented. In other examples, several recommendations are presented. In this example, a user can decide which of the recommendations that are presented via the UI are best suited for their circumstances. For example, if the recommendation recommends using product X or product Y, the user may use product Y since the user only has access to product Y.

In an example, if the user does not have access to a product that the recommendation recommends to use, the recommendation can provide a link to, for example to a website, to allow the user to order the product. If at least one recommendation is not associated with a location, the method (400) can provide this feedback to, for example, an administrator of the cleaning system such that products and/or recommendations can be developed for that location.

In some examples, if more than one recommendation is presented, the recommendations can be ordered. For example, if three recommendations, such as recommendation A, recommendation B, and recommendation C are determined to be able to improve cleanliness of the item when cleaning the item with the cleaning device, these recommendations can be ordered based on optimal cleaning results. In this example, recommendation A is presented before recommendation B because recommendation A provides the best cleaning results. Recommendation B is presented before recommendation C because recommendation B provides better cleaning results than recommendation C.

In an example, the UI is integrated into the mobile device. As a result, the method (400) presents the recommendation on the UI of the mobile device. In another example, the UI is integrated into the cleaning device. As a result, the method (400) presents the recommendation on the UI of the cleaning device.

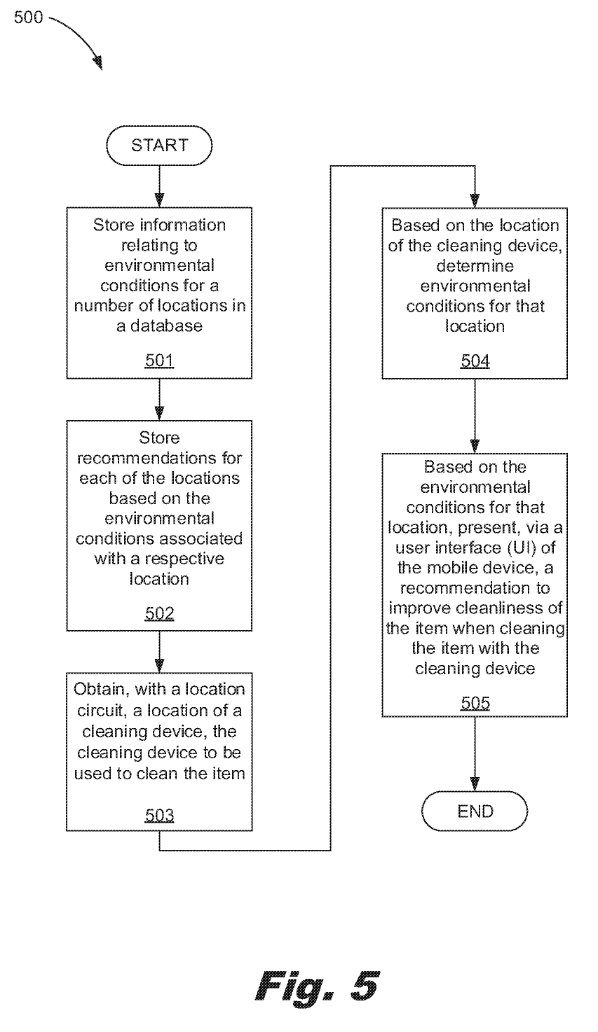

FIG. 5 is a flowchart of a method for cleaning an item, according to one example of principles described herein. In one example, the method (500) is executed by the system (100) of FIG. 1. In other examples, the method (500) is executed by other systems such as system 200, system 600 or system 700. In this example, the method (500) includes storing (501) information relating to the environmental conditions for a number of locations in a database, storing (502) recommendations for each of the locations based on the environmental conditions associated with a respective location, obtaining (503), with a location circuit, a location of a cleaning device, the cleaning device to be used to clean the item, based on the location of the cleaning device, determining (504) environmental conditions for that location, based on the environmental conditions for that location, and presenting (505), via a UI, a recommendation to improve cleanliness of the item when cleaning the item with the cleaning device.

As mentioned above, the method (500) includes storing (501) information relating to the environmental conditions for a number of locations in a database. The environmental conditions for the number of locations in the database may be based on historical information obtained from a number of other sources. These sources include other databases, websites, scientific studies, other sources, or combinations thereof. In some examples, the environmental conditions for the number of locations in the database are manually created as entries in the database for each of the locations. In other examples, information is extracted from these sources via a number of techniques. Techniques such as natural language processing (NLP), optical character recognition (ORC), other techniques, or combinations thereof are used to extract the information from these sources.

As mentioned above, the method (500) includes storing (502) recommendations for each of the locations based on the environmental conditions associated with a respective location. In some examples, more than one recommendation is stored in the database for each of the locations. Some of the recommendations are based on the time of year. For example, during strawberry season for a location, one recommendation is optimal for that location. However, once strawberry season has concluded, another recommendation is optimal for that location.

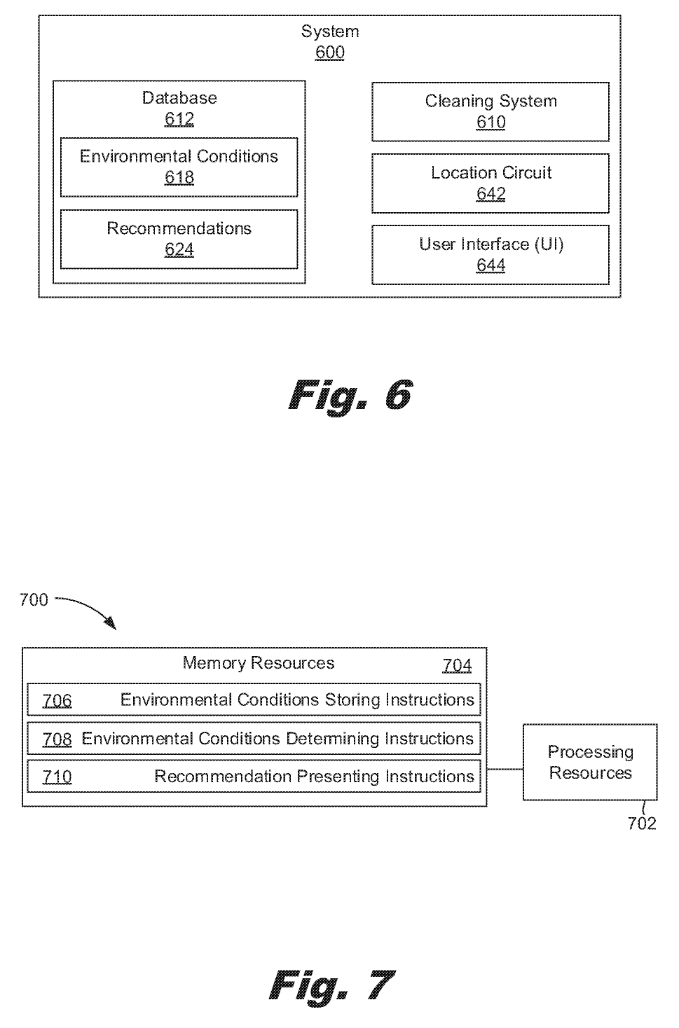

FIG. 6 is a diagram of a system for cleaning an item, according to one example of the principles described herein. As will be described below, the system (600) includes a database and a cleaning system.

As illustrated, the system (600) includes a database (612). The database (612) stores information relating to environmental conditions (618) for a number of locations. The database (612) stores recommendations (624) for each of the locations based on environmental conditions (618) associated with a respective location.

As illustrated, the system (600) includes a cleaning system (640). The cleaning system (610) obtains, with a location circuit (642), a location of a cleaning device to be used to clean the item. The cleaning system (610) accesses the database (612). The cleaning system (610) determines, based on the location of the cleaning device, the environmental conditions (618) for that location. The cleaning system (610) presents, with a UI (644), based on the environmental conditions (618) for that location, at least one of the recommendations (624) to improve cleanliness of the item when cleaning the item with the cleaning device.

FIG. 7 is a diagram of a cleaning system, according to one example of the principles described herein. In this example, the cleaning system (700) includes resource(s) (702) that are in communication with a machine-readable storage medium (704). Resource(s) (702) may include one processor. In another example, the resource(s) (702) may further include at least one processor and other resources used to process instructions. The machine-readable storage medium (704) represents generally any memory capable of storing data such as instructions or data structures used by the cleaning system (700). The instructions shown stored in the machine-readable storage medium (704) include environmental conditions storing instructions (706), environmental conditions determining instructions (708) and recommendation presenting instructions (710).

The machine-readable storage medium (704) contains computer readable program code to cause tasks to be executed by the resource(s) (702). The machine-readable storage medium (704) may be tangible and/or physical storage medium. The machine-readable storage medium (704) may be any appropriate storage medium that is not a transmission storage medium. A non-exhaustive list of machine-readable storage medium types includes non-volatile memory, volatile memory, random access memory, write only memory, flash memory, electrically erasable program read only memory, or types of memory, or combinations thereof.

The environmental conditions storing instructions (706) represents instructions that, when executed, cause the resource(s) (702) to store information relating to environmental conditions for a number of locations. The environmental conditions determining instructions (708) represents instructions that, when executed, cause the resource(s) (702) to based on a location of a cleaning device, determine the environmental conditions for that location. The recommendation presenting instructions (710) represents instructions that, when executed, cause the resource(s) (702) to based on the environmental conditions for that location, present, via a UI, a recommendation to improve cleanliness of an item when cleaning the item with the cleaning device.

Further, the machine-readable storage medium (704) may be part of an installation package. In response to installing the installation package, the instructions of the machine-readable storage medium (704) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the resource(s) (702) and the machine-readable storage medium (704) are located within the same physical component, such as a server, or a network component. The machine-readable storage medium (704) may be part of the physical component's main memory, caches, registers, non-volatile memory, or elsewhere in the physical component's memory hierarchy. Alternatively, the machine-readable storage medium (704) may be in communication with the resource(s) (702) over a network. Further, the data structures, such as the libraries, may be accessed from a remote location over a network connection while the programmed instructions are located locally. Thus, the cleaning system (700) may be implemented on a user device, on a server, on a collection of servers, or combinations thereof.

The cleaning system (700) of FIG. 7 may be part of a general purpose computer. However, in alternative examples, the cleaning system (700) is part of an application specific integrated circuit.

The terminology used herein is for the purpose of describing particular examples, and is not intended to be limiting. As used herein, the singular forms “a,” “an” and “the” are intended to include the plural forms as well, unless the context clearly indicated otherwise. It will be further understood that the terms “comprises” and/or “comprising” when used in the specification, specify the presence of stated features, integers, operations, elements, and/or components, but do not preclude the presence or addition of a number of other features, integers, operations, elements, components, and/or groups thereof.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for cleaning an item, the method comprising, with a cleaning system programmed to perform the method:
obtaining, with a location circuit, a location of a cleaning device, the cleaning device to be used to clean the item;
based on the location of the cleaning device, determining environmental conditions for that location; and
based on the environmental conditions for that location, presenting, via a user interface (UI), a recommendation to improve cleanliness of the item when cleaning the item with the cleaning device.

2. The method of claim 1, further comprising storing information relating to the environmental conditions for a number of locations in a database.

3. The method of claim 2, further comprising storing recommendations for each of the locations based on the environmental conditions associated with a respective location.

4. The method of claim 1, wherein the location comprises a house address, a city, a county, a country, a continent, a longitudinal coordinate, a latitudinal coordinate, or combinations thereof.

5. The method of claim 1, wherein the environmental conditions comprise common stains associated with the location, a type of soil for the location, water conditions for the location, regional foods associated with the location, current weather conditions for the location, or combinations thereof.

6. The method of claim 1, wherein the recommendation comprises utilizing a specific cleaning process, a specific detergent, a specific bleach, a specific water temperature, specific settings of the cleaning device, or combinations thereof for cleaning the item with the cleaning device.

7. The method of claim 1, wherein the location circuit and the UI are integrated into a mobile device.

8. The method of claim 1, wherein the location circuit and the UI are integrated into the cleaning device.

9. A system for cleaning an item, the system comprising:
a database to:
store information relating to environmental conditions for a number of locations; and
store recommendations for each of the locations based on environmental conditions associated with a respective location; and
a cleaning system to:
with a location circuit, obtain a location of a cleaning device to be used to clean the item;
access the database;
based on the location of the cleaning device, determine the environmental conditions for that location; and
with a user interface (UI), present, based on the environmental conditions for that location, at least one of the recommendations to improve cleanliness of the item when cleaning the item with the cleaning device.

10. The system of claim 9, wherein each of the locations comprises a house address, a city, a county, a country, a continent, a longitudinal coordinate, a latitudinal coordinate, or combinations thereof.

11. The system of claim 9, wherein the environmental conditions comprise common stains associated with each of the locations, a type of soil for each of the locations, water conditions for each of the locations, regional foods associated with each of the locations, current weather conditions for each of the locations, or combinations thereof.

12. The system of claim 9, wherein each of the recommendations comprise utilizing a specific cleaning process, a specific detergent, a specific bleaching agent, a specific water temperature, specific settings of the cleaning device, or combinations thereof for cleaning the item with the cleaning device.

13. A machine-readable, non-volatile storage medium encoded with instructions, the instructions executable by a processor of a system to cause the system to:
store information relating to environmental conditions for a number of locations;
based on a location of a cleaning device, determine the environmental conditions for that location; and
based on the environmental conditions for that location, present, via a user interface (UI), a recommendation to improve cleanliness of an item when cleaning the item with the cleaning device.

14. The machine-readable, non-volatile storage medium of claim 13, further comprising instructions that, when executed, cause the processor to store recommendations for each of the locations based on environmental conditions associated with a respective location.

15. The machine-readable, non-volatile storage medium of claim 13, wherein each of the locations comprises a house address, a city, a county, a country, a continent, a longitudinal coordinate, a latitudinal coordinate, or combinations thereof.

16. The machine-readable, non-volatile storage medium of claim 13, wherein the environmental conditions comprise common stains associated with each of the locations, a type of soil for each of the locations, water conditions for each of the locations, regional foods associated with each of the locations, current weather conditions for each of the locations, or combinations thereof.

17. The machine-readable, non-volatile storage medium of claim 13, wherein the recommendation comprises utilizing a specific cleaning process, a specific detergent, a specific bleaching agent, a specific water temperature, specific settings of the cleaning device, or combinations thereof for cleaning the item with the cleaning device.

18. The machine-readable, non-volatile storage medium of claim 13, wherein a location circuit and the UI are integrated into a mobile device

19. The machine-readable, non-volatile storage medium of claim 13, wherein a location circuit and the UI are integrated into the cleaning device

20. The machine-readable, non-volatile storage medium of claim 13, further comprising instructions that, when executed, cause the processor to obtain, via a location circuit, the location of the cleaning device, the cleaning device used to clean the item.
